(19) United States
(12) Patent Application Publication
(10) Pub. No.: US 2022/0187432 A1
(43) Pub. Date: Jun. 16, 2022

(54) SYSTEMS AND METHODS FOR CALIBRATING A CAMERA AND A LIDAR

(71) Applicant: BEIJING VOYAGER TECHNOLOGY CO., LTD., Beijing (CN)

(72) Inventor: Zhen WANG, Beijing (CN)

(73) Assignee: BEIJING VOYAGER TECHNOLOGY CO., LTD., Beijing (CN)

(21) Appl. No.: 17/653,458

(22) Filed: Mar. 3, 2022

Related U.S. Application Data
(63) Continuation of application No. PCT/CN2019/107224, filed on Sep. 23, 2019.

(51) Int. Cl. G01S 7/497; G01S 7/48; G01S 17/86; G01S 17/931; G06T 7/80

(52) U.S. Cl. CPC G01S 7/497; G01S 7/4808; G01S 7/4802; G01S 17/931; G06T 7/80; G01S 17/86

(57) ABSTRACT

The present disclosure relates to a system and a method for calibrating and a camera and a LIDAR of an autonomous vehicle. The system may perform the method to: obtain a first projection of a target object from the camera when the autonomous vehicle is at a first distance from the target object; obtain 3D data of the target object from the LIDAR when the autonomous vehicle is at a second distance from the target object, wherein the first distance is greater than the second distance; determine a second projection of the target object based on the 3D data, wherein the second projection is an estimated projection of the target object when the autonomous vehicle is at the first distance from the target object; and determine a first relative pose of the camera relative to the LIDAR based on the first projection and the second projection.

### CROSS-REFERENCE TO THE RELATED APPLICATIONS

This application is a continuation of International Application No. PCT/CN2019/107224, filed on Sep. 23, 2019, the contents of which are hereby incorporated by reference.

### TECHNICAL FIELD

This present disclosure generally relates to systems and methods for autonomous driving, and in particular, to systems and methods for calibrating a camera and a LIDAR of an autonomous vehicle.

### BACKGROUND

Autonomous vehicles, combining a variety of sensors, have become increasingly popular. An onboard LIDAR and camera play important roles in driving automation. However, in some situations, the LIDAR may only obtain dense data of a target object within a short distance, e.g., 0-60 meters. The camera and the LIDAR thus are able to be calibrated only using the data obtained within the short distance, and the resulted calibration is inaccurate for detecting objects from a remote distance. Therefore, it is desirable to provide systems and methods for calibrating the camera and the LIDAR to improve the accuracy of detecting objects from the remote distance.

### SUMMARY

An aspect of the present disclosure introduces a system for calibrating a camera and a LIDAR of an autonomous vehicle. The system may include at least one storage medium including a set of instructions for calibrating the camera and the LIDAR; and at least one processor in communication with the storage medium, wherein when executing the set of instructions, the at least one processor is directed to: obtain a first projection of a target object from the camera when the autonomous vehicle is at a first distance from the target object; obtain 3D data of the target object from the LIDAR when the autonomous vehicle is at a second distance from the target object, wherein the first distance is greater than the second distance; determine a second projection of the target object based on the 3D data, wherein the second projection is an estimated projection of the target object when the autonomous vehicle is at the first distance from the target object; and determine a first relative pose of the camera relative to the LIDAR based on the first projection and the second projection.

In some embodiments, the first projection is aligned with the second projection.

In some embodiments, to determine the second projection of the target object, the at least one processor is further directed to: obtain a first vehicle pose of the autonomous vehicle relative to a terrestrial coordinate system when the autonomous vehicle is at the first distance from the target object; and obtain a first LIDAR pose of the LIDAR relative to the autonomous vehicle when the autonomous vehicle is at the first distance from the target object.

In some embodiments, the at least one processor is further directed to: obtain a second vehicle pose of the autonomous vehicle relative to the terrestrial coordinate system when the autonomous vehicle is at the second distance from the target object; and obtain a second LIDAR pose of the LIDAR relative to the autonomous vehicle when the autonomous vehicle is at the second distance from the target object.

In some embodiments, the at least one processor is further directed to: obtain an object pose of the target object relative to the LIDAR when the autonomous vehicle is at the second distance from the target object.

In some embodiments, the at least one processor is further directed to: determine the second projection of the target object based on the 3D data, the first vehicle pose of the autonomous vehicle, the first LIDAR pose of the LIDAR, the second vehicle pose of the autonomous vehicle, the second LIDAR pose of the LIDAR, and the object pose of the target object.

In some embodiments, the at least one processor is further directed to: obtain a third projection of the target object from the camera when the autonomous vehicle is at the second distance from the target object; and determine a second relative pose of the camera relative to the LIDAR based on the third projection of the target object and the 3D data of the target object.

According to another aspect of the present disclosure, a method for calibrating a camera and a LIDAR of an autonomous vehicle. The method may include obtaining a first projection of a target object from the camera when the autonomous vehicle is at a first distance from the target object; obtaining 3D data of the target object from the LIDAR when the autonomous vehicle is at a second distance from the target object, wherein the first distance is greater than the second distance; determining a second projection of the target object based on the 3D data, wherein the second projection is an estimated projection of the target object when the autonomous vehicle is at the first distance from the target object; and determining a first relative pose of the camera relative to the LIDAR based on the first projection and the second projection.

According to still another aspect of the present disclosure, a non-transitory computer-readable medium, comprising at least one set of instructions compatible for calibrating a camera and a LIDAR. When executed by at least one processor of an electrical device, the at least one set of instructions directs the at least one processor to perform a method. The method may include obtaining a first projection of a target object from the camera when the autonomous vehicle is at a first distance from the target object; obtaining 3D data of the target object from the LIDAR when the autonomous vehicle is at a second distance from the target object, wherein the first distance is greater than the second distance; determining a second projection of the target object based on the 3D data, wherein the second projection is an estimated projection of the target object when the autonomous vehicle is at the first distance from the target object; and determining a first relative pose of the camera relative to the LIDAR based on the first projection and the second projection.

According to still another aspect of the present disclosure, a system for calibrating a camera and a LIDAR may include a first projection obtaining module, configured to obtain a first projection of a target object from the camera when the autonomous vehicle is at a first distance from the target object; a 3D data obtaining module, configured to obtain 3D data of the target object from the LIDAR when the autonomous vehicle is at a second distance from the target object, wherein the first distance is greater than the second distance; a second projection determining module, configured to determine a second projection of the target object based on the 3D data, wherein the second projection is an estimated projection of the target object when the autonomous vehicle is at the first distance from the target object; and a first relative pose determining module, configured to determine a first relative pose of the camera relative to the LIDAR based on the first projection and the second projection.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting schematic embodiments, in which like reference numerals represent similar structures throughout the several views of the drawings, and wherein:

FIG. 1 is a schematic diagram illustrating an exemplary autonomous driving system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device on which a terminal device may be implemented according to some embodiments of the present disclosure;

FIG. 4 is a block diagram illustrating an exemplary processing device according to some embodiments of the present disclosure;

FIG. 5 is a flowchart illustrating an exemplary process for calibrating a camera and a LIDAR of an autonomous vehicle according to some embodiments of the present disclosure;

FIG. 6 is a flowchart illustrating an exemplary process for determining a second projection of a target object according to some embodiments of the present disclosure; and

FIG. 7 is a flowchart illustrating an exemplary process for determining a second relative pose of the camera relative to the LIDAR according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding calibrating a camera and a LIDAR in an autonomous driving system, it should be understood that this is only one exemplary embodiment. The systems and methods of the present disclosure may be applied to any other kind of transportation system. For example, the systems and methods of the present disclosure may be applied to transportation systems of different environments including land, ocean, aerospace, or the like, or any combination thereof. The autonomous vehicle of the transportation systems may include a taxi, a private car, a hitch, a bus, a train, a bullet train, a high-speed rail, a subway, a vessel, an aircraft, a spaceship, a hot-air balloon, or the like, or any combination thereof.

An aspect of the present disclosure relates to systems and methods for calibrating a camera and a LIDAR of an autonomous vehicle. The systems and methods may use 3D data of a target object from a short distance from the autonomous vehicle obtained from the LIDAR to predict a projection of the target object. The predicted projection may predict a projection of the target object assuming that the target object is from a remote distance from the autonomous vehicle. The systems and methods may further align the predicted projection with a real projection of the target object obtained from the camera at the remote distance from the autonomous vehicle to calculate a relative pose of the camera relative to the LIDAR. In this way, the camera and the LIDAR may be calibrated to improve the accuracy of detecting objects at the remote distance.

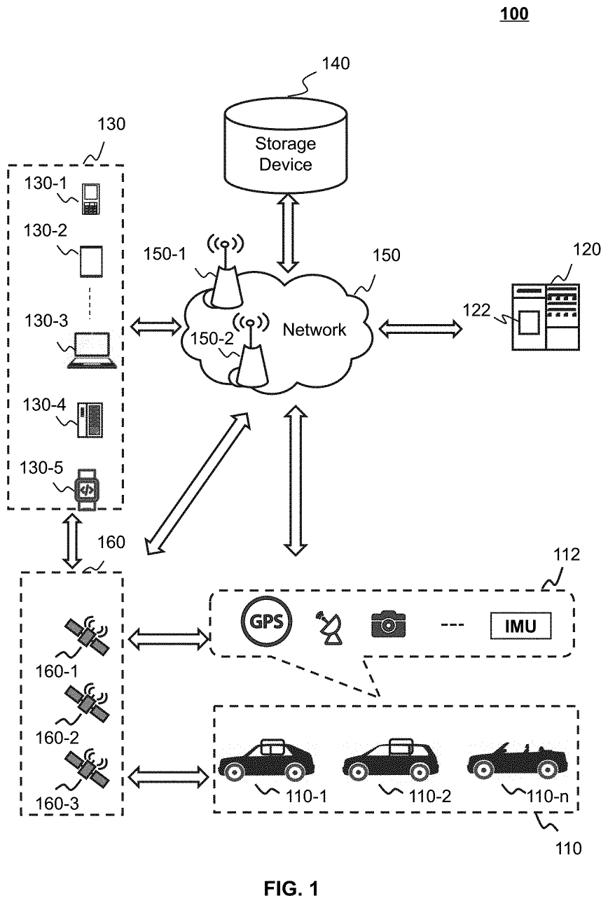

FIG. 1 is a schematic diagram illustrating an exemplary autonomous driving system 100 according to some embodiments of the present disclosure. In some embodiments, the autonomous driving system 100 may include a vehicle 110 (e.g. vehicle 110-1, 110-2 . . . and/or 110-n), a server 120, a terminal device 130, a storage device 140, a network 150, and a positioning and navigation system 160.

The vehicle 110 may be any type of autonomous vehicles, unmanned aerial vehicles, etc. An autonomous vehicle or unmanned aerial vehicle may refer to a vehicle that is capable of achieving a certain level of driving automation. Exemplary levels of driving automation may include a first level at which the vehicle is mainly supervised by a human and has a specific autonomous function (e.g., autonomous steering or accelerating), a second level at which the vehicle has one or more advanced driver assistance systems (ADAS) (e.g., an adaptive cruise control system, a lane-keep system) that can control the braking, steering, and/or acceleration of the vehicle, a third level at which the vehicle is able to drive autonomously when one or more certain conditions are met, a fourth level at which the vehicle can operate without human input or oversight but still is subject to some constraints (e.g., be confined to a certain area), a fifth level at which the vehicle can operate autonomously under all circumstances, or the like, or any combination thereof.

In some embodiments, the vehicle 110 may have equivalent structures that enable the vehicle 110 to move around or fly. For example, the vehicle 110 may include structures of a conventional vehicle, for example, a chassis, a suspension, a steering device (e.g., a steering wheel), a brake device (e.g., a brake pedal), an accelerator, etc. As another example, the vehicle 110 may have a body and at least one wheel. The body may be any body style, such as a sports vehicle, a coupe, a sedan, a pick-up truck, a station wagon, a sports utility vehicle (SUV), a minivan, or a conversion van. The at least one wheel may be configured to as all-wheel drive (AWD), front wheel drive (FWR), rear wheel drive (RWD), etc. In some embodiments, it is contemplated that vehicle 110 may be an electric vehicle, a fuel cell vehicle, a hybrid vehicle, a conventional internal combustion engine vehicle, etc.

In some embodiments, the vehicle 110 may be capable of sensing its environment and navigating with one or more detecting units 112. The plurality of detection units 112 may include a global position system (GPS) module, a radar (e.g., a light detection and ranging (LiDAR)), an inertial measurement unit (IMU), a camera, or the like, or any combination thereof. The radar (e.g., LiDAR) may be configured to scan the surrounding and generate point-cloud data. The point-cloud data then may be used to make digital 3-D representations of one or more objects surrounding the vehicle 110. The GPS module may refer to a device that is capable of receiving geolocation and time information from GPS satellites and then to calculate the device's geographical position. The IMU sensor may refer to an electronic device that measures and provides a vehicle's specific force, an angular rate, and sometimes the magnetic field surrounding the vehicle, using various inertial sensors. The various inertial sensors may include an acceleration sensor (e.g., a piezoelectric sensor), a velocity sensor (e.g., a Hall sensor), a distance sensor (e.g., a radar, a LIDAR, an infrared sensor), a steering angle sensor (e.g., a tilt sensor), a traction-related sensor (e.g., a force sensor), etc. The camera may be configured to obtain one or more images relating to objects (e.g., a person, an animal, a tree, a roadblock, a building, or a vehicle) that are within the scope of the camera.

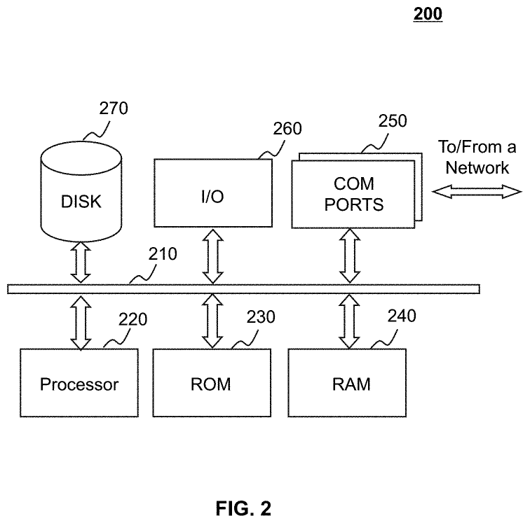

In some embodiments, the server 120 may be a single server or a server group. The server group may be centralized or distributed (e.g., the server 120 may be a distributed system). In some embodiments, the server 120 may be local or remote. For example, the server 120 may access information and/or data stored in the terminal device 130, the detecting units 112, the vehicle 110, the storage device 140, and/or the positioning and navigation system 160 via the network 150. As another example, the server 120 may be directly connected to the terminal device 130, the detecting units 112, the vehicle 110, and/or the storage device 140 to access stored information and/or data. In some embodiments, the server 120 may be implemented on a cloud platform or an onboard computer. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 120 may be implemented on a computing device 200 having one or more components illustrated in FIG. 2 in the present disclosure.

In some embodiments, the server 120 may include a processing device 122. The processing device 122 may process information and/or data associated with autonomous driving to perform one or more functions described in the present disclosure. For example, the processing device 122 may calibrate the camera and the LIDAR. In some embodiments, the processing device 122 may include one or more processing engines (e.g., single-core processing engine(s) or multi-core processor(s)). Merely by way of example, the processing device 122 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof. In some embodiments, the processing device 122 may be integrated into the vehicle 110 or the terminal device 130.

In some embodiments, the terminal device 130 may include a mobile device 130-1, a tablet computer 130-2, a laptop computer 130-3, a built-in device in a vehicle 130-4, a wearable device 130-5, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the server 120 may be integrated into the terminal device 130. In some embodiments, the terminal device 130 may be a device with positioning technology for locating the location of the terminal device 130.

The storage device 140 may store data and/or instructions. In some embodiments, the storage device 140 may store data obtained from the vehicle 110, the detecting units 112, the processing device 122, the terminal device 130, the positioning and navigation system 160, and/or an external storage device. For example, the storage device 140 may store LIDAR data (e.g., 3D data of a target object) obtained from the LIDAR in the detecting units 112. As another example, the storage device 140 may store camera data (e.g., images or a projection of the target object) obtained from the camera in the detecting units 112. In some embodiments, the storage device 140 may store data and/or instructions that the server 120 may execute or use to perform exemplary methods described in the present disclosure. For example, the storage device 140 may store instructions that the processing device 122 may execute or use to calibrate the camera and the LIDAR. In some embodiments, the storage device 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 150 to communicate with one or more components (e.g., the server 120, the terminal device 130, the detecting units 112, the vehicle 110, and/or the positioning and navigation system 160) of the autonomous driving system 100. One or more components of the autonomous driving system 100 may access the data or instructions stored in the storage device 140 via the network 150. In some embodiments, the storage device 140 may be directly connected to or communicate with one or more components (e.g., the server 120, the terminal device 130, the detecting units 112, the vehicle 110, and/or the positioning and navigation system 160) of the autonomous driving system 100. In some embodiments, the storage device 140 may be part of the server 120. In some embodiments, the storage device 140 may be integrated into the vehicle 110.

The network 150 may facilitate exchange of information and/or data. In some embodiments, one or more components (e.g., the server 120, the terminal device 130, the detecting units 112, the vehicle 110, the storage device 140, or the positioning and navigation system 160) of the autonomous driving system 100 may send information and/or data to other component(s) of the autonomous driving system 100 via the network 150. For example, the server 120 may obtain LIDAR data (e.g., 3D data of the target object) or camera data (e.g., images or a projection of the target object) from the vehicle 110, the terminal device 130, the storage device 140, and/or the positioning and navigation system 160 via the network 150. In some embodiments, the network 150 may be any type of wired or wireless network, or combination thereof. Merely by way of example, the network 150 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 150 may include one or more network access points. For example, the network 150 may include wired or wireless network access points (e.g., 150-1, 150-2), through which one or more components of the autonomous driving system 100 may be connected to the network 150 to exchange data and/or information.

The positioning and navigation system 160 may determine information associated with an object, for example, the terminal device 130, the vehicle 110, etc. In some embodiments, the positioning and navigation system 160 may include a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, a current time, etc. The positioning and navigation system 160 may include one or more satellites, for example, a satellite 160-1, a satellite 160-2, and a satellite 160-3. The satellites 160-1 through 160-3 may determine the information mentioned above independently or jointly. The satellite positioning and navigation system 160 may send the information mentioned above to the network 150, the terminal device 130, or the vehicle 110 via wireless connections.

One of ordinary skill in the art would understand that when an element (or component) of the autonomous driving system 100 performs, the element may perform through electrical signals and/or electromagnetic signals. For example, when the terminal device 130 transmits out a request to the server 120, a processor of the terminal device 130 may generate an electrical signal encoding the request. The processor of the terminal device 130 may then transmit the electrical signal to an output port. If the terminal device 130 communicates with the server 120 via a wired network, the output port may be physically connected to a cable, which further may transmit the electrical signal to an input port of the server 120. If the terminal device 130 communicates with the server 120 via a wireless network, the output port of the terminal device 130 may be one or more antennas, which convert the electrical signal to an electromagnetic signal. Within an electronic device, such as the terminal device 130 and/or the server 120, when a processor thereof processes an instruction, transmits out an instruction, and/or performs an action, the instruction and/or action is conducted via electrical signals. For example, when the processor retrieves or saves data from a storage medium (e.g., the storage device 140), it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of an exemplary computing device according to some embodiments of the present disclosure. In some embodiments, the server 120 and/or the terminal device 130 may be implemented on the computing device 200. For example, the processing device 122 may be implemented on the computing device 200 and configured to perform functions of the processing device 122 disclosed in this disclosure.

The computing device 200 may be used to implement any component of the autonomous driving system 100 of the present disclosure. For example, the processing device 122 of the autonomous driving system 100 may be implemented on the computing device 200, via its hardware, software program, firmware, or a combination thereof. Although only one such computer is shown for convenience, the computer functions related to the autonomous driving system 100 as described herein may be implemented in a distributed manner on a number of similar platforms to distribute the processing load.

The computing device 200 may include communication (COM) ports 250 connected to and from a network (e.g., the network 150) connected thereto to facilitate data communications. The computing device 200 may also include a processor (e.g., a processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms, for example, a disk 270, and a read-only memory (ROM) 230, or a random access memory (RAM) 240, for various data files to be processed and/or transmitted by the computing device 200. The exemplary computing device 200 may also include program instructions stored in the ROM 230, the RAM 240, and/or another type of non-transitory storage medium to be executed by the processor 220. The methods and/or processes of the present disclosure may be implemented as the program instructions. The computing device 200 also includes an I/O component 260, supporting input/output between the computing device 200 and other components therein. The computing device 200 may also receive programming and data via network communications.

Merely for illustration, only one processor is described in the computing device 200. However, it should be noted that the computing device 200 in the present disclosure may also include multiple processors, and thus operations that are performed by one processor as described in the present disclosure may also be jointly or separately performed by the multiple processors. For example, the processor of the computing device 200 executes both operation A and operation B. As another example, operation A and operation B may also be performed by two different processors jointly or separately in the computing device 200 (e.g., the first processor executes operation A and the second processor executes operation B, or the first and second processors jointly execute operations A and B).

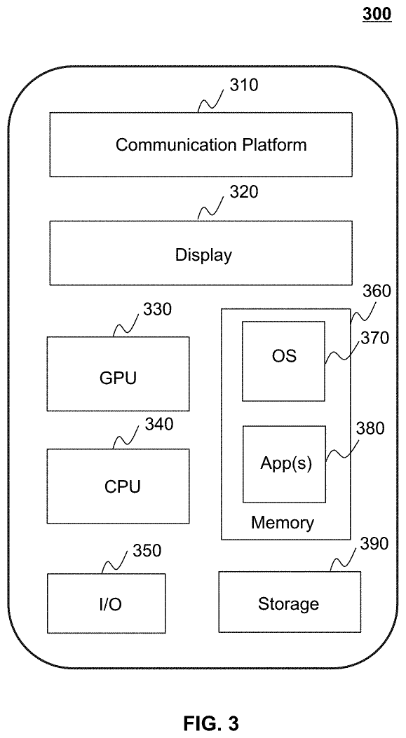

FIG. 3 is a schematic diagram illustrating exemplary hardware and/or software components of an exemplary mobile device on which a terminal device may be implemented according to some embodiments of the present disclosure. In some embodiments, the terminal device 130 may be implemented on the mobile device 300. As illustrated in FIG. 3, the mobile device 300 may include a communication platform 310, a display 320, a graphics processing unit (GPU) 330, a central processing unit (CPU) 340, an I/O 350, a memory 360, a mobile operating system (OS) 370, and storage 390. In some embodiments, any other suitable component, including but not limited to a system bus or a controller (not shown), may also be included in the mobile device 300.

In some embodiments, the mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile app for receiving and rendering information relating to positioning or other information from the processing device 122. User interactions with the information stream may be achieved via the I/O 350 and provided to the processing device 122 and/or other components of the autonomous driving system 100 via the network 150.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

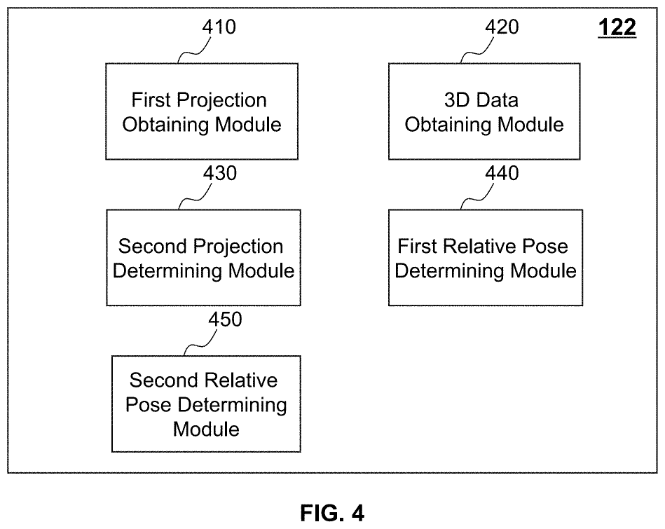

FIG. 4 is a block diagram illustrating an exemplary processing device 122 according to some embodiments of the present disclosure. The processing device 122 may include a first projection obtaining module 410, a 3D data obtaining module 420, a second projection determining module 430, a first relative pose determining module 440, and a second relative pose determining module 450.

The first projection obtaining module 410 may be configured to obtain a first projection of a target object from the camera when the autonomous vehicle is at a first distance from the target object.

The 3D data obtaining module 420 may be configured to obtain 3D data of the target object from a LIDAR when the autonomous vehicle is at a second distance from the target object.

The second projection determining module 430 may be configured to determine a second projection of the target object based on the 3D data. For example, the second projection determining module 430 may obtain a first vehicle pose of the autonomous vehicle relative to a terrestrial coordinate system and a first LIDAR pose of the LIDAR relative to the autonomous vehicle when the autonomous vehicle is at the first distance from the target object. As another example, the second projection determining module 430 may obtain a second vehicle pose of the autonomous vehicle relative to the terrestrial coordinate system, a second LIDAR pose of the LIDAR relative to the autonomous vehicle, and an object pose of the target object relative to the LIDAR when the autonomous vehicle is at the second distance from the target object. As still another example, the second projection determining module 430 may determine the second projection of the target object based on the 3D data, the first vehicle pose of the autonomous vehicle, the first LIDAR pose of the LIDAR, the second vehicle pose of the autonomous vehicle, the second LIDAR pose of the LIDAR, and the object pose of the target object.

The first relative pose determining module 440 may be configured to determine a first relative pose of the camera relative to the LIDAR based on the first projection and the second projection.

The second relative pose determining module 450 may be configured to determine a second relative pose of the camera relative to the LIDAR when the autonomous vehicle is at the second distance from the target object. For example, the second relative pose determining module 450 may obtain a third projection of the target object from the camera when the autonomous vehicle is at the second distance from the target object. As another example, the second relative pose determining module 450 may determine a second relative pose of the camera relative to the LIDAR based on the third projection of the target object and the 3D data of the target object.

The modules in the processing device 122 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the processing device 122 may include a storage module (not shown) used to store information and/or data (e.g., the LIDAR data, the camera data, etc.) associated with calibrating the camera and the LIDAR.

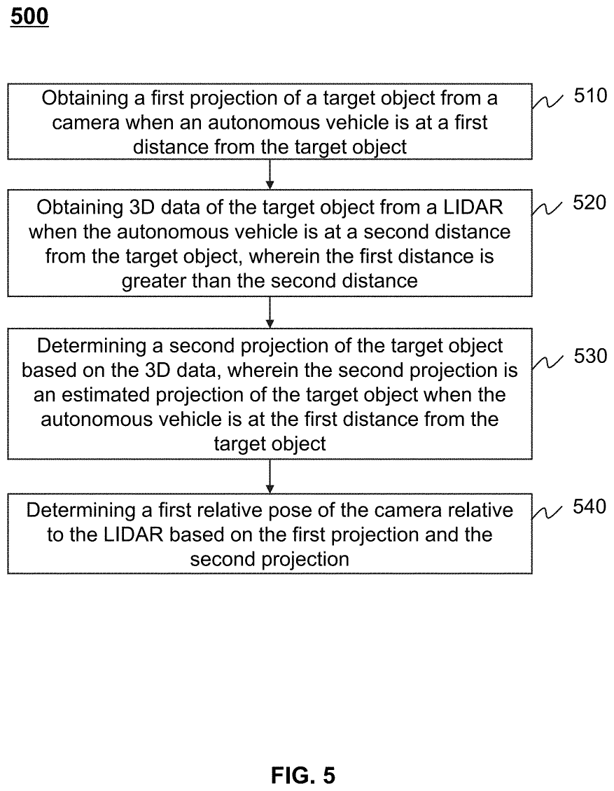

FIG. 5 is a flowchart illustrating an exemplary process 500 for calibrating a camera and a LIDAR of an autonomous vehicle according to some embodiments of the present disclosure. In some embodiments, the process 500 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 500. The operations of the illustrated process presented below are intended to be illustrative. In some embodiments, the process 500 may be accomplished with one or more additional operations not described and/or without one or more of the operations herein discussed. Additionally, the order in which the operations of the process as illustrated in FIG. 5 and described below is not intended to be limiting.

In 510, the processing device 122 (e.g., the first projection obtaining module 410, the interface circuits of the processor 220) may obtain a first projection of a target object from the camera when the autonomous vehicle is at a first distance from the target object.

In some embodiments, the target object may be a reference object for calibrating the camera. For example, the target object may include a planar board having fixed spacing patterns thereon. For example, the fixed spacing patterns may include a checkerboard, fixed spacing circle array patterns, or the like, or any combination thereof. In some embodiments, the target object may be placed in view of the camera, so that the camera can capture images of the target object. For example, the target object may be placed at the first distance from the autonomous vehicle. The first distance may be a predetermined distance set by the processing device 122 or an operator of the processing device 122. For example, the first distance may be within a predetermined range, such as 60 to 1000 meters.

In some embodiments, the camera may capture images or videos of the target object. The camera may project the target object on an image plane to obtain the first projection of the target object. The processing device 122 may obtain the first project of the target object from the camera via the network 150.

In 520, the processing device 122 (e.g., the 3D data obtaining module 420, the interface circuits of the processor 220) may obtain 3D data of the target object from a LIDAR when the autonomous vehicle is at a second distance from the target object.

In some embodiments, the target object may be placed in front of the LIDAR, so that the LIDAR can detect the target object. For example, the target object may be placed at the second distance from the autonomous vehicle. The second distance may be a predetermined distance set by the processing device 122 or the operator of the processing device 122. For example, the second distance may be within a predetermined range, such as 0 to 60 meters. In some embodiments, the first distance may be greater than the second distance. For example, the first distance is 500 meters and the second distance is 50 meters. In some embodiments, the LIDAR may scan the target object to obtain the 3D data of the target object. The processing device 122 may obtain the 3D data of the target object from the LIDAR via the network 150.

In 530, the processing device 122 (e.g., the second projection determining module 430) may determine a second projection of the target object based on the 3D data. In some embodiments, the second projection may be an estimated projection of the target object when the autonomous vehicle is at the first distance from the target object.

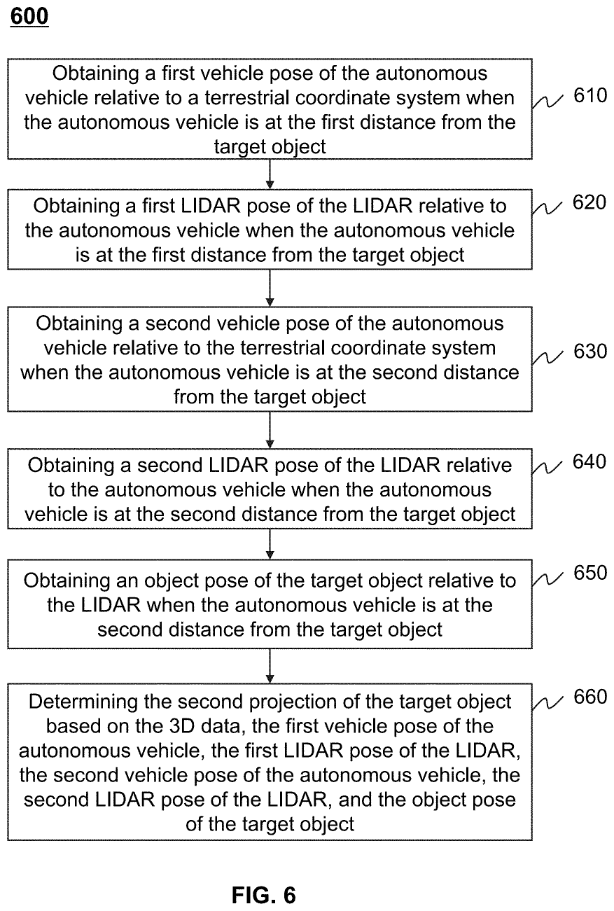

In some embodiments, the LIDAR may only obtain little information of the target when the autonomous vehicle is at the first distance from the target object. The processing device 122 may use the 3D data of the target object obtained at the second distance to predict the second projection of the target object assuming that the target object is at the first distance from the autonomous vehicle. In some embodiments, the processing device 122 may determine the second projection using the 3D data of the target object obtained at the second distance according to a projection function. For example, the processing device 122 may obtain a plurality of relative poses between the autonomous vehicle and the LIDAR, between the autonomous vehicle and a terrestrial coordinate system. The processing device 122 may further determine the second projection using the plurality of relative poses and the 3D data of the target object according to the projection function. The process or method for determining the second projection may be found elsewhere in the present disclosure (e.g., FIG. 6 and the descriptions thereof).

In 540, the processing device 122 (e.g., the first relative pose determining module 440) may determine the first relative pose of the camera relative to the LIDAR based on the first projection and the second projection.

In some embodiments, the first relative pose of the camera relative to the LIDAR pose may reflect a calibration result of the camera and the LIDAR associated with a remoter first distance compared with the second distance. The first relative pose may be determined using the first projection of the target object when the autonomous vehicle is at the first distance from the target object and the predicted second projection of the target object assuming that the autonomous vehicle is at the first distance from the target object. In some embodiments, the processing device 122 may determine the first relative pose when the first projection and the second projection is aligned with each other. For example, the processing device 122 may determine the first relative pose according to Equation (1) below:

$$= {argmin}_{{P}_{C}^{L}} f ( m , {m}^{′} ) , \qquad ( 1 )$$

wherein m depicts the first projection; m′ depicts the second projection; ƒ(m, m′) depicts a function depicting a degree of alignment between the first projection and the second projection; P_{C}^{L} depicts a variable of the first relative pose; and [symbol] depicts the first relative pose. According to Equation (1), the processing device 122 may determine the first relative pose when the first projection is aligned with the second projection. That is to say, the processing device 122 may vary values of the variable of the first relative pose P_{C}^{L}, and determine a value of the variable of the first relative pose P_{C}^{L} when the function ƒ(m, m′), which depicts the degree of alignment between the first projection and the second projection, is the minimum, as the first relative pose [symbol] .

In some embodiments, the first relative pose of the camera relative to the LIDAR may reflect an orientation, a position, an attitude, or a rotation of the camera relative to LIDAR when the autonomous vehicle is at the first distance from the target object. The first relative pose may include 6 degrees-of-freedom (DOF) which are made up of the rotation (roll, pitch, and yaw) and 3D translation of the camera with respect to the LIDAR. For example, the first relative pose may be represented as an Euler angle, a Rotation matrix, an Orientation quaternion, or the like, or any combination thereof.

In some embodiments, the first relative pose of the camera relative to the LIDAR may be used for detecting remote objects about which the LIDAR may obtain little information. Using the first relative pose, the accuracy of detecting the remote objects may be improved.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional operations (e.g., a storing operation) may be added elsewhere in the process 500. In the storing operation, the processing device 122 may store information and/or data (e.g., the first relative pose between the camera and the LIDAR) in a storage device (e.g., the storage device 140) disclosed elsewhere in the present disclosure.

FIG. 6 is a flowchart illustrating an exemplary process 600 for determining a second projection of the target object according to some embodiments of the present disclosure. In some embodiments, the process 600 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 600. The operations of the illustrated process presented below are intended to be illustrative. In some embodiments, the process 600 may be accomplished with one or more additional operations not described and/or without one or more of the operations herein discussed. Additionally, the order in which the operations of the process as illustrated in FIG. 6 and described below is not intended to be limiting.

In 610, the processing device 122 (e.g., the second projection determining module 430) may obtain a first vehicle pose of the autonomous vehicle relative to a terrestrial coordinate system when the autonomous vehicle is at the first distance from the target object.

In some embodiments, the autonomous vehicle may include one or more sensors for sensing locations of the autonomous vehicle. For example, the autonomous vehicle may include a GPS and an IMU. The GPS and IMU may work together to identify a location of the autonomous vehicle when the autonomous vehicle is at the first distance from the target object. The location may indicate the first vehicle pose of the autonomous vehicle (or the IMU) relative to the terrestrial coordinate system. The processing device 122 may obtain the first vehicle pose form the GPS and IMU via the network 150.

In 620, the processing device 122 (e.g., the second projection determining module 430) may obtain a first LIDAR pose of the LIDAR relative to the autonomous vehicle when the autonomous vehicle is at the first distance from the target object.

In some embodiments, the processing device 122 may calibrate the LIDAR and the IMU of the autonomous vehicle when the autonomous vehicle is at the first distance from the target object, and store the first LIDAR pose in a storage (e.g., the storage device 140, the ROM 230, the RAM 240, etc.). The processing device 122 may access the storage to obtain the first LIDAR pose. In some embodiments, the processing device 122 may calibrate the LIDAR and the IMU of the autonomous vehicle based on one or more other sensors (e.g., a camera) of the autonomous vehicle when the autonomous vehicle is at the first distance from the target object. For example, the processing device 122 may obtain a calibration result P_{C}^{L} of the LIDAR and the camera and a calibration result P_{C}^{I1} of the camera and the IMU when the autonomous vehicle is at the first distance from the target object. The processing device 122 may determine the first LIDAR pose P_{L}^{I1} of the LIDAR relative to the autonomous vehicle based on the calibration result of the LIDAR and the camera and the calibration result of the IMU and the camera. For example, the first LIDAR pose P_{L}^{I1} may be a product of the calibration result P_{L}^{C} of the LIDAR and the camera and the calibration result P_{C}^{I1} of the camera and the IMU.

In 630, the processing device 122 (e.g., the second projection determining module 430) may obtain a second vehicle pose of the autonomous vehicle relative to the terrestrial coordinate system when the autonomous vehicle is at the second distance from the target object.

In some embodiments, the GPS and IMU may work together to identify a location of the autonomous vehicle when the autonomous vehicle is at the second distance from the target object. The location may indicate the second vehicle pose of the autonomous vehicle (or the IMU) relative to the terrestrial coordinate system. The processing device 122 may obtain the second vehicle pose form the GPS and IMU via the network 150.

In 640, the processing device 122 (e.g., the second projection determining module 430) may obtain a second LIDAR pose of the LIDAR relative to the autonomous vehicle when the autonomous vehicle is at the second distance from the target object.

In some embodiments, the processing device 122 may calibrate the LIDAR and the IMU of the autonomous vehicle when the autonomous vehicle is at the second distance from the target object, and store the second LIDAR pose in a storage (e.g., the storage device 140, the ROM 230, the RAM 240, etc.). The processing device 122 may access the storage to obtain the second LIDAR pose. In some embodiments, the processing device 122 may calibrate the LIDAR and the IMU of the autonomous vehicle based on one or more other sensors (e.g., the camera) of the autonomous vehicle when the autonomous vehicle is at the second distance from the target object. For example, the processing device 122 may obtain a calibration result P_{L}^{C} of the LIDAR and the camera and a calibration result P_{C}^{I2} of the camera and the IMU when the autonomous vehicle is at the second distance from the target object. The processing device 122 may determine the second LIDAR pose P_{L}^{I2} of the LIDAR relative to the autonomous vehicle based on the calibration result of the LIDAR and the camera and the calibration result of the IMU and the camera. For example, the second LIDAR pose P_{L}^{I2} may be a product of the calibration result P_{L}^{C} of the LIDAR and the camera and the calibration result P_{C}^{I2} of the camera and the IMU.

In 650, the processing device 122 (e.g., the second projection determining module 430) may obtain an object pose of the target object relative to the LIDAR when the autonomous vehicle is at the second distance from the target object.

In some embodiments, the LIDAR may scan the target object when the autonomous vehicle is at the second distance from the target object to obtain the object pose.

In 660, the processing device 122 (e.g., the second projection determining module 430) may determine the second projection of the target object based on the 3D data, the first vehicle pose of the autonomous vehicle, the first LIDAR pose of the LIDAR, the second vehicle pose of the autonomous vehicle, the second LIDAR pose of the LIDAR, and the object pose of the target object.

In some embodiments, the processing device 122 may determine the second projection according to a projection function. For example, the processing device 122 may determine the second projection according to Equation (2) below:

m′=π(P_{C}^{L}P_{I2}^{L}P_{E}^{I2}P_{I1}^{E}P_{L}^{I1}P_{M}^{L}M) (2),

wherein m′ depicts the second projection; P_{L}^{C} depicts a pose of the LIDAR relative to the camera; π depicts a projection function; P_{I2}^{L} depicts a transposed matrix of the second LIDAR pose P_{L}^{I2} of the LIDAR relative to the autonomous vehicle; P_{E}^{I2} depicts a transposed matrix of the second vehicle pose P_{I2}^{E} of the autonomous vehicle relative to the terrestrial coordinate system; P_{I1}^{E} depicts the first vehicle pose of the autonomous vehicle relative to the terrestrial coordinate system; P_{L}^{I1} depicts the first LIDAR pose of the LIDAR relative to the autonomous vehicle; P_{M}^{L} depicts the object pose of the target object relative to the LIDAR; and M depicts the 3D data of the target object.

According to Equation (1) and Equation (2), the processing device 122 may determine the first relative pose according to Equation (3) below:

$$\tilde{{P}_{L}^{C}} = {argmin}_{{P}_{L}^{C}} f ( m , π ( {P}_{L}^{C} {P}_{I 2}^{L} {P}_{E}^{I 2} {P}_{I 1}^{E} {P}_{L}^{I 1} {P}_{M}^{L} M ) ) , \qquad ( 3 )$$

wherein P_{L}^{C} depicts a variable of a transposed matrix of the first relative pose P_{C}^{L}; and [symbol] depicts a transposed matrix of the first relative pose [symbol] . According to Equation (3), the processing device 122 may determine the first relative pose when the first projection is aligned with the second projection. That is to say, the processing device 122 may vary values of the variable P_{L}^{C}, and determine a value of the variable P_{L}^{C} when the function ƒ(m, m′), which depicts the degree of alignment between the first projection and the second projection, is the minimum, as the value of [symbol] , and further determine the first relative pose [symbol] .

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional operations (e.g., a storing operation) may be added elsewhere in the process 600. In the storing operation, the processing device 122 may store information and/or data (e.g., the first vehicle pose, the first LIDAR pose, the second vehicle pose, the second LIDAR pose, the object pose, etc.) in a storage device (e.g., the storage device 140) disclosed elsewhere in the present disclosure.

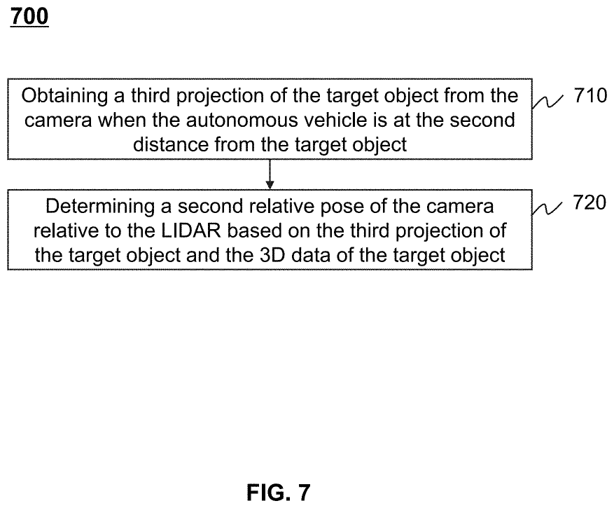

FIG. 7 is a flowchart illustrating an exemplary process 700 for determining a second relative pose of the camera relative to the LIDAR according to some embodiments of the present disclosure. In some embodiments, the process 700 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 700. The operations of the illustrated process presented below are intended to be illustrative. In some embodiments, the process 700 may be accomplished with one or more additional operations not described and/or without one or more of the operations herein discussed. Additionally, the order in which the operations of the process as illustrated in FIG. 7 and described below is not intended to be limiting.

In 710, the processing device 122 (e.g., the second relative pose determining module 450) may obtain a third projection of the target object from the camera when the autonomous vehicle is at the second distance from the target object.

In some embodiments, the camera may capture images or videos of the target object when the autonomous vehicle is at the second distance from the target object. The camera may project the target object on an image plane to obtain the third projection of the target object. The processing device 122 may obtain the third project of the target object from the camera via the network 150.

In 720, the processing device 122 (e.g., the second relative pose determining module 450) may determine a second relative pose of the camera relative to the LIDAR based on the third projection of the target object and the 3D data of the target object.

In some embodiments, the second relative pose of the camera relative to the LIDAR pose may indicate a calibration result of the camera and the LIDAR associated with a closer second distance compared with the first distance. In some embodiments, the processing device 122 may determine the second relative pose using data obtained from the camera and the LIDAR when the autonomous vehicle is at the second distance from the target object. For example, the processing device 122 may determine the second relative pose based on the third projection and the 3D data of the target object according to a perspective-n-point (PnP) method. As another example, the processing device 122 may match feature points in the third projection with the corresponding feature points in the 3D data, and determine the second relative pose according to adjusting the positions of the feature points.

In some embodiments, the second relative pose of the camera relative to the LIDAR may reflect an orientation, a position, an attitude, or a rotation of the camera relative to LIDAR when the autonomous vehicle is at the second distance from the target object. The second relative pose may include 6 degrees-of-freedom (DOF) which are made up of the rotation (roll, pitch, and yaw) and 3D translation of the camera with respect to the LIDAR. For example, the second relative pose may be represented as an Euler angle, a Rotation matrix, an Orientation quaternion, or the like, or any combination thereof.

In some embodiments, the second relative pose of the camera relative to the LIDAR may be used for detecting objects from a short distance where the LIDAR may obtain much information about the objects. In some embodiments, the first relative pose and the second relative pose may be used in combination to improve the accuracy of detecting the objects either at the remote distance or at the short distance.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional operations (e.g., a storing operation) may be added elsewhere in the process 700. In the storing operation, the processing device 122 may store information and/or data (e.g., the third projection of the target object) in a storage device (e.g., the storage device 140) disclosed elsewhere in the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for calibrating a camera and a LIDAR of an autonomous vehicle, comprising:
at least one storage medium including a set of instructions for calibrating the camera and the LIDAR; and
at least one processor in communication with the storage medium, wherein when executing the set of instructions, the at least one processor is directed to:
obtain a first projection of a target object from the camera when the autonomous vehicle is at a first distance from the target object;
obtain 3D data of the target object from the LIDAR when the autonomous vehicle is at a second distance from the target object, wherein the first distance is greater than the second distance;
determine a second projection of the target object based on the 3D data, wherein the second projection is an estimated projection of the target object when the autonomous vehicle is at the first distance from the target object; and
determine a first relative pose of the camera relative to the LIDAR based on the first projection and the second projection.

2. The system of claim 1, wherein the first projection is aligned with the second projection.

3. The system of claim 1, wherein to determine the second projection of the target object, the at least one processor is further directed to:
obtain a first vehicle pose of the autonomous vehicle relative to a terrestrial coordinate system when the autonomous vehicle is at the first distance from the target object; and
obtain a first LIDAR pose of the LIDAR relative to the autonomous vehicle when the autonomous vehicle is at the first distance from the target object.

4. The system of claim 3, wherein the at least one processor is further directed to:
obtain a second vehicle pose of the autonomous vehicle relative to the terrestrial coordinate system when the autonomous vehicle is at the second distance from the target object; and
obtain a second LIDAR pose of the LIDAR relative to the autonomous vehicle when the autonomous vehicle is at the second distance from the target object.

5. The system of claim 4, wherein the at least one processor is further directed to:
obtain an object pose of the target object relative to the LIDAR when the autonomous vehicle is at the second distance from the target object.

6. The system of claim 5, wherein the at least one processor is further directed to:
determine the second projection of the target object based on the 3D data, the first vehicle pose of the autonomous vehicle, the first LIDAR pose of the LIDAR, the second vehicle pose of the autonomous vehicle, the second LIDAR pose of the LIDAR, and the object pose of the target object.

7. The system of claim 1, wherein the at least one processor is further directed to:
obtain a third projection of the target object from the camera when the autonomous vehicle is at the second distance from the target object; and
determine a second relative pose of the camera relative to the LIDAR based on the third projection of the target object and the 3D data of the target object.

8. A method for calibrating a camera and a LIDAR of an autonomous vehicle, implemented on a computing device including at least one storage medium including a set of instructions, and at least one processor in communication with the storage medium, the method comprising:
obtaining a first projection of a target object from the camera when the autonomous vehicle is at a first distance from the target object;
obtaining 3D data of the target object from the LIDAR when the autonomous vehicle is at a second distance from the target object, wherein the first distance is greater than the second distance;
determining a second projection of the target object based on the 3D data, wherein the second projection is an estimated projection of the target object when the autonomous vehicle is at the first distance from the target object; and
determining a first relative pose of the camera relative to the LIDAR based on the first projection and the second projection.

9. The method of claim 8, wherein the first projection is aligned with the second projection.

10. The method of claim 8, wherein the determining the second projection of the target object further includes:
obtaining a first vehicle pose of the autonomous vehicle relative to a terrestrial coordinate system when the autonomous vehicle is at the first distance from the target object; and
obtaining a first LIDAR pose of the LIDAR relative to the autonomous vehicle when the autonomous vehicle is at the first distance from the target object.

11. The method of claim 10 further comprising:
obtaining a second vehicle pose of the autonomous vehicle relative to the terrestrial coordinate system when the autonomous vehicle is at the second distance from the target object; and
obtaining a second LIDAR pose of the LIDAR relative to the autonomous vehicle when the autonomous vehicle is at the second distance from the target object.

12. The method of claim 11 further comprising:
obtaining an object pose of the target object relative to the LIDAR when the autonomous vehicle is at the second distance from the target object.

13. The method of claim 12 further comprising:
determining the second projection of the target object based on the 3D data, the first vehicle pose of the autonomous vehicle, the first LIDAR pose of the LIDAR, the second vehicle pose of the autonomous vehicle, the second LIDAR pose of the LIDAR, and the object pose of the target object.

14. The method of claim 8 further comprising:
obtaining a third projection of the target object from the camera when the autonomous vehicle is at the second distance from the target object; and
determining a second relative pose of the camera relative to the LIDAR based on the third projection of the target object and the 3D data of the target object.

15. A non-transitory readable medium, comprising at least one set of instructions for calibrating a camera and a LIDAR of an autonomous vehicle, wherein when executed by at least one processor of an electrical device, the at least one set of instructions directs the at least one processor to perform a method, the method comprising:
obtaining a first projection of a target object from the camera when the autonomous vehicle is at a first distance from the target object;
obtaining 3D data of the target object from the LIDAR when the autonomous vehicle is at a second distance from the target object, wherein the first distance is greater than the second distance;
determining a second projection of the target object based on the 3D data, wherein the second projection is an estimated projection of the target object when the autonomous vehicle is at the first distance from the target object; and
determining a first relative pose of the camera relative to the LIDAR based on the first projection and the second projection.

16. The non-transitory readable medium of claim 15, wherein the first projection is aligned with the second projection.

17. The non-transitory readable medium of claim 15, wherein the determining the second projection of the target object further includes:
obtaining a first vehicle pose of the autonomous vehicle relative to a terrestrial coordinate system when the autonomous vehicle is at the first distance from the target object; and
obtaining a first LIDAR pose of the LIDAR relative to the autonomous vehicle when the autonomous vehicle is at the first distance from the target object.

18. The non-transitory readable medium of claim 17, wherein the method further includes:
obtaining a second vehicle pose of the autonomous vehicle relative to the terrestrial coordinate system when the autonomous vehicle is at the second distance from the target object; and
obtaining a second LIDAR pose of the LIDAR relative to the autonomous vehicle when the autonomous vehicle is at the second distance from the target object.

19. The non-transitory readable medium of claim 17, wherein the method further includes:
obtaining an object pose of the target object relative to the LIDAR when the autonomous vehicle is at the second distance from the target object; and
determining the second projection of the target object based on the 3D data, the first vehicle pose of the autonomous vehicle, the first LIDAR pose of the LIDAR, the second vehicle pose of the autonomous vehicle, the second LIDAR pose of the LIDAR, and the object pose of the target object.

20. (canceled)

21. The non-transitory readable medium of claim 15, wherein the method further comprises:
obtain a third projection of the target object from the camera when the autonomous vehicle is at the second distance from the target object; and
determine a second relative pose of the camera relative to the LIDAR based on the third projection of the target object and the 3D data of the target object.
